(19) United States
(12) Patent Application Publication
(10) Pub. No.: US 2012/0075440 A1
(43) Pub. Date: Mar. 29, 2012

(54) ENTROPY BASED IMAGE SEPARATION

(75) Inventors: Disha Ahuja, San Diego, CA (US); I-Ting Fang, Stanford, CA (US); Bolan Jiang, San Diego, CA (US); Aditya Sharma, San Diego, CA (US)

(73) Assignee: QUALCOMM Incorporated, San Diego, CA (US)

(21) Appl. No.: 12/892,764

(22) Filed: Sep. 28, 2010

(51) Int. Cl. G06K 9/34; H04N 7/18

(52) U.S. Cl. 348/61; 382/100; 382/173; 348/E07.085

(57) ABSTRACT

Entropy based image segmentation determines entropy values for pixels in an image based on intensity or edge orientation. One or more threshold values are determined as a fraction of the entropy distribution over the image. For example, high and/or low thresholds may be generated to identify regions in the image associated with trees or sky, respectively. The entropy values are compared to the threshold(s) from which regions within the image can be segmented. Intensity based entropy has no structural information, and thus, proximity based clustering and pruning of the entropy points is performed. A mask may be applied to the segmented regions to remove the regions from the image, which is useful in, e.g., objection recognition processes. Additionally, separate buildings may be identified and segmented using edge orientation entropy with clustering and pruning.

### BACKGROUND

Image segmentation is a process in which a digital image is partitioned into multiple regions, making the image easier to analyze. Image segmentation tools generally require manual intervention from the user or are semi-automated in that the user inputs initial seeds that are used for foreground/background separation. Examples of image segmentation include region growing methods, which require initial seeds, manually choosing foreground/background, and histogram techniques. Additionally, most of these image segmentation techniques require large computations and are very processor intensive. An automatic segmentation algorithm, such as that described by P. Felzenszwalb et al. in “Efficient Graph-Based Image Segmentation”, International Journal of Computer Vision, Volume 59, Number 2, September 2004, is slow and does not work well on areas such as building or trees. Consequently, conventional image segmentation techniques are poorly suited for unskilled users or for use in mobile type applications.

### SUMMARY

Entropy based image segmentation determines entropy values for pixels in an image based on intensity or edge orientation and removes vegetation in the image using a maximum entropy threshold and removes the background in the image by removing pixels with an entropy value less than a minimum entropy threshold or by removing pixels with a calculated edge strength value that is less than a minimum threshold. Entropy based image segmentation can be completely automated; requiring no manual input or initial seeds, and is a fast process suitable to be implemented on a mobile platform as well as a server. Intensity based entropy has no structural information, and thus, location based clustering and pruning of the entropy points is performed. Edge orientation entropy, on the other hand, intrinsically includes structural information, and thus, additional clustering and pruning is not necessary when appropriate thresholds are generated and applied. A mask may be applied to the segmented regions to remove the regions from the image, which is useful in, e.g., objection recognition processes. Additionally, separate structures may be identified and segmented using edge orientation entropy with the application of clustering and pruning.

### BRIEF DESCRIPTION OF THE DRAWING

FIG. 1 illustrates an example of a mobile platform that includes a camera and is capable of segmenting captured images using an entropy based image segmentation process.

FIG. 2 is a block diagram of the mobile platform that is capable of performing the entropy based image segmentation process.

FIG. 3 is a flow chart illustrating the entropy based image segmentation process on a captured image.

FIG. 4 is a flow chart illustrating the process of determining entropy values using intensities of the pixels in an image.

FIGS. 5A and 5B illustrate windowed pixel regions that may be used to determine intensity based entropy within an image.

FIG. 6 illustrates the maximum intensity based entropy plotted for different window sizes.

FIG. 7 is an example of a captured image upon which the entropy based image segmentation process may be performed.

FIG. 8 is an intensity entropy profile of the image from FIG. 7.

FIG. 9 illustrates the distribution of entropy over the image from FIG. 7 as an entropy histogram.

FIG. 10 illustrates the distribution of entropy over the image from FIG. 7 as a cumulative distribution function (CDF) of the intensity entropy.

FIG. 11 is a flow chart illustrating the general process of segmenting the image to remove regions with entropy values outside the threshold range using clustering and pruning.

FIG. 12 is a flow chart illustrating in more detail segmenting the image to remove regions with entropy values outside the threshold range using clustering and pruning.

FIG. 13 illustrates the image from FIG. 7 after clustering high entropy points using k-means with the number of clusters N=5.

FIG. 14 illustrates the clusters to be removed, i.e., segmented from the image of FIG. 7, after outlier pruning.

FIG. 15 illustrates the image from FIG. 7 with a final mask created using the segmented clusters from FIG. 14.

FIG. 16 illustrates the image from FIG. 7 with a final mask created using the points in the clusters of FIG. 14 using morphological techniques.

FIG. 17 is a flow chart illustrating the process of determining entropy values of the pixels in an image using edge orientation.

FIG. 18 is an edge orientation entropy profile of the image from FIG. 7.

FIG. 19 illustrates the image from FIG. 7 with a final mask created after applying a threshold to identify regions in the image with large edge entropy.

FIG. 20 is a flow chart illustrating a method of separating structures, such as buildings, in an image.

FIGS. 21A-G illustrate different relationships between two example clusters that may be considered to belong to one structure in an image.

FIG. 22 illustrates edge orientation entropy points with clustering using k-means with N=5 in an image with multiple buildings.

FIG. 23 illustrates the image from FIG. 22 after cluster selection and pruning.

FIG. 24 illustrates the image from FIG. 22 after the clusters are merged to identify the separate buildings.

### DETAILED DESCRIPTION

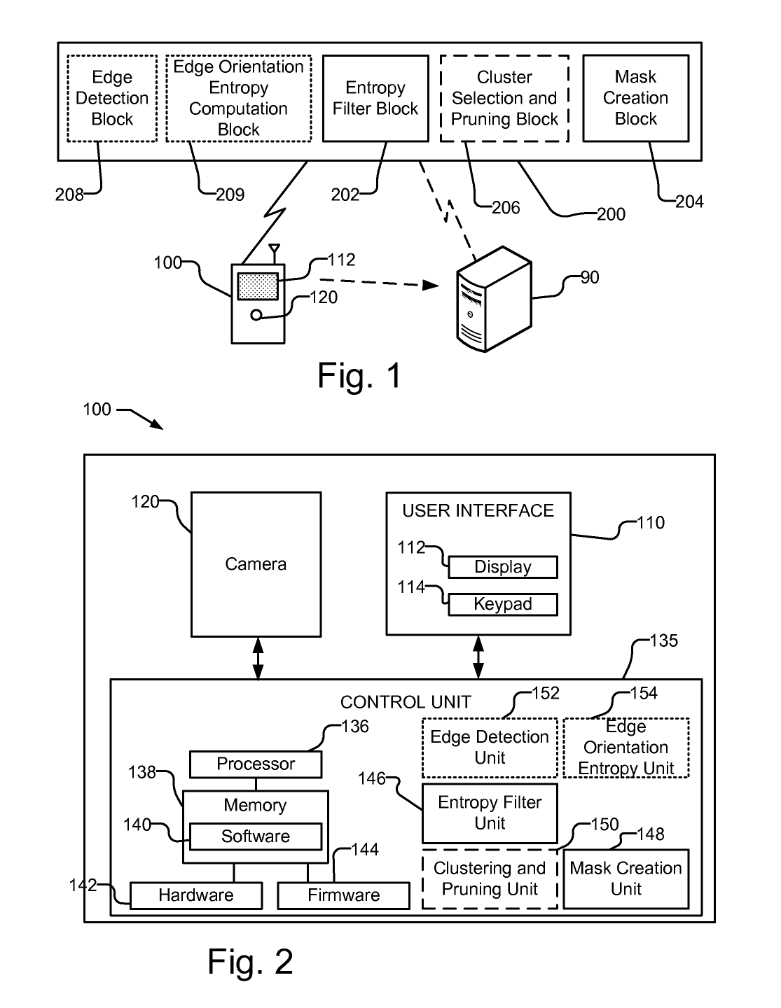

FIG. 1 illustrates an example of a mobile platform 100 that includes a camera 120 and display 112 and is capable of segmenting captured images using an entropy based image segmentation process 200. The use of entropy for segmentation is advantageous as it can be completely automated; requiring no manual input or initial seeds, and is a fast process and is thus suitable to be implemented on a mobile platform 100. If desired, the mobile platform 100 may communicate the captured image to a server 90, as illustrated by the dashed arrow, which may perform the entropy based image segmentation process 200. The segmented image may then be used, e.g., in object recognition, e.g., augmented reality, or other similar process, with selected features, such as trees and background, removed from the image. Moreover, if desired, the entropy based image segmentation process 200 may be performed on only selected areas of a captured image, as opposed to the entire image. For example, selected areas may be regions in the captured image that are determined to have an entropy that is neither too low nor too high. As illustrated in FIG. 1, the entropy based image segmentation process 200 includes an entropy filter block 202 and a mask creation block 204. The entropy filter block 202 filters the image based on entropy values, where points, i.e., pixels, with entropy values smaller than or within a threshold are retained. The thresholds are selected so that target regions, such as trees or background, are identified. For example, high thresholds may be generated to identify regions in the image associated with vegetation, e.g., trees and bushes, or other such undesired features, while low thresholds may be generated to identify regions associated with a homogenous background, such as sky, ground, pathways, etc. The mask creation block 204 creates a final mask that follows the contour of the segmented image by using morphological operations or the cluster information can be used to create a solid square mask. The result is an image with features, such as vegetation, and background removed.

The entropy values used in the entropy based image segmentation process 200 may be based, e.g., on pixel intensity or edge orientation. With the use of entropy based on intensity, an additional clustering and pruning block 206, illustrated with dashed lines in FIG. 1, is included to identify and segment the target features. The cluster selection and pruning block 206 clusters together points with high entropy, e.g., based on their proximity. Each cluster is pruned for outliers and assessed for its “quality”, where various statistical measures may be used to determine whether to retain the cluster or a part of it, or discard the entire cluster. With the use of edge orientation entropy, on the other hand, a preliminary edge detection block 208 and edge orientation entropy computation block 209, illustrated with dotted lines, are included, but with proper threshold adjustment, the entropy filter block 202 identifies the target regions without clustering. The edge detection block 208 is used to detect edges, while the edge orientation entropy computation block 209 discards pixels with low edge strength and builds an orientation histogram from which the entropy can be computed.

As used herein, a mobile platform refers to a device such as a cellular or other wireless communication device, personal communication system (PCS) device, personal navigation device (PND), Personal Information Manager (PIM), Personal Digital Assistant (PDA), laptop or other suitable mobile device. Also, “mobile platform” is intended to include all devices, including wireless communication devices, computers, laptops, etc. which are capable of communication with a server, such as via the Internet, WiFi, or other network. The mobile platform 100 may access online servers using various wireless communication networks such as a wireless wide area network (WWAN), a wireless local area network (WLAN), a wireless personal area network (WPAN), and so on, using cellular towers and from wireless communication access points, or satellite vehicles. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

FIG. 2 is a block diagram of the mobile platform 100 that is capable of performing the entropy based image segmentation process 200. The mobile platform 100 includes a camera 120 for capturing images. It should be understood that while FIG. 2 describes a mobile platform 100, a server 90 capable of performing the entropy based image segmentation process 200 may be similarly configured, but without the camera 120 and instead with an external interface to receive images from e.g., mobile platform 100 as illustrated in FIG. 1, or other sources.

The camera 120 is connected to and communicates with a mobile platform control unit 135. The mobile platform control unit 135 may be provided by a processor 136 and associated memory 138, software 140, hardware 142, and firmware 144. The mobile platform control unit 135 includes an entropy filter unit 146, mask creation unit 148, as well as optional clustering and pruning unit 150, edge detection unit 152, and edge orientation entropy unit 154, which are illustrated separately from processor 136 for clarity, but may implanted using software 140 that is run in the processor 136, or in hardware 142 or firmware 144. It will be understood as used herein that the processor 136 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

The mobile platform 100 also includes a user interface 110 that is in communication with the mobile platform control unit 135, e.g., the mobile platform control unit 135 accepts data from and controls the user interface 110. The user interface 110 includes a display 112, as well as a keypad 114 or other input device through which the user can input information into the mobile platform 100. In one embodiment, the keypad 114 may be integrated into the display 112, such as a touch screen display. The user interface 110 may also include a microphone and speaker, e.g., when the mobile platform 100 is a cellular telephone.

The methodologies described herein may be implemented by various means depending upon the application. For example, these methodologies may be implemented in hardware 142, firmware 144, software 140, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 138 and executed by the processor 136. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

For example, software 140 codes may be stored in memory 138 and executed by the processor 136 and may be used to run the processor and to control the operation of the mobile platform 100 as described herein. A program code stored in a computer-readable medium, such as memory 138, may include program code to produce a gray scale image from a captured image that includes a background and vegetation; program code to segment the image to remove the background and vegetation to produce a segmented image, comprising: program code to determine entropy values for pixels in the image; program code to compare the entropy values to a threshold value for maximum entropy; program code to remove regions in the image having entropy values greater than the threshold value for maximum entropy to remove vegetation from the image; wherein the background is removed using a minimum threshold value that is compared to at least one of the entropy values for pixels in the image and an edge strength value calculated for each pixel while determining entropy values; and program code to store the segmented image in the memory. If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The mobile platform 100, thus, may include a means for producing a gray scale image that includes a background and vegetation; means for segmenting the image to remove the background and vegetation from the image to produce a segmented image, the means for segmenting the image comprising: means for determining entropy values for pixels in the image; means for comparing the entropy values to a threshold value for maximum entropy; means for removing regions in the image having entropy values greater than the threshold value for maximum entropy to remove vegetation from the image; wherein the background is removed using a minimum threshold value that is compared to at least one of the entropy values for pixels in the image and an edge strength value calculated for each pixel while determining entropy values; and means for storing the segmented image, which may be implemented by the one or more of the entropy filter unit 146, clustering and pruning unit 150, as well as the edge detection unit 152 and edge orientation entropy unit 154, which may be embodied in hardware 142, firmware 144, or in software 140 run in the processor 136 or some combination thereof. The mobile platform 100 may further include means for determining clusters of entropy regions based on proximity, and means for statistically analyzing each cluster to determine whether to retain or remove the cluster, which may be implemented by the clustering and pruning unit 150, which may be embodied in hardware 142, firmware 144, or in software 140 run in the processor 136 or some combination thereof. The mobile platform 100 may further include means for filtering the image using entropy and retaining points with entropy values larger than a threshold, means for partitioning the retained points into clusters based on color and location, means for removing outliers based on color and location, and means for merging clusters based on at least one of overlap area, distance, color, and vertical overlay ratio to separate structures, such as buildings, in the image, which may be implemented by the entropy filter unit and clustering and pruning unit 150, which may be embodied in hardware 142, firmware 144, or in software 140 run in the processor 136 or some combination thereof.

Entropy is an information-theoretic concept, and specifies the degree of randomness associated with a random variable. In other words, entropy describes the expected amount of information contained in a random variable. It relates the probability of occurrence of an event, with the amount of ‘new’ information it conveys. In accordance with the definition, a random event X that occurs with probability P(X) contains I(X) units of information as follows, where I(X) is the ‘self-information’ contained in X.

$$I ( X ) = log ( \frac{1}{P ( X )} ) = - log ( P ( X ) ) \qquad eq . 1$$

From equation 1, it can be seen, that if P(X)=1, then I(X)=0 i.e., if the event always occurs, then it conveys no information. Thus, the information content or entropy is inversely related to the probability of occurrence of the event. The average region entropy is calculated as:

$${E}_{region} = - {\sum }_{i ∈ region} {P}_{i} * log ( {P}_{i} ) \qquad eq . 2$$

where Pᵢ is the frequency of the value i within the region of interest. Intensity based entropy is being used to characterize the texture of images, and thus, the event is defined by the appearance of a gray level within a region of interest, which may be a windowed pixel region. Edge orientation based entropy, on the other hand, characterizes structural information in the form of edges in the image, and thus, the event is defined by the orientation of the edge, where the region of interest includes all the pixels to be analyzed, which may be less than the entire image and may be selected based on pixels that have an edge strength value greater than a threshold.

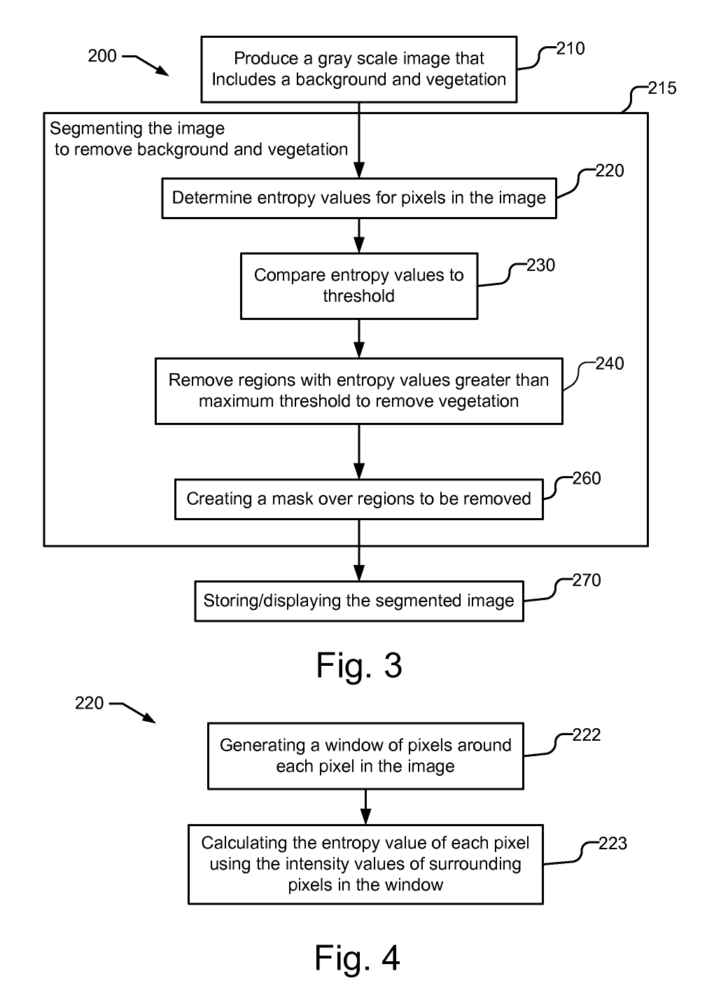

FIG. 3 is a flow chart illustrating the entropy based image segmentation process 200 on a captured image that includes a background, e.g., sky, road, path, field etc., and vegetation, e.g., trees, bushes, shrubs, etc. To verify whether an image is a good candidate for intensity based entropy segmentation, a histogram of the entropy points or a cumulative distribution function (CDF) of the intensity entropy of the entire image may be examined to see the percentage of the points have high entropy. If most of the image has high entropy (i.e. skewed Gaussian distribution), then the image may not be a candidate for intensity based entropy segmentation process and edge orientation based entropy may be used. For example, after calculating intensity based entropy over the entire image, if it is determined that the percentage of high entropy points, entropy>4, relative to all entropy points is greater than, e.g., 80%, then the image is not a good candidate for intensity based entropy segmentation. If the percentage is between, e.g., 70%-80%, the intensity based entropy segmentation may be used, but with efficiency loses, while lower percentages, e.g., ≦70%, indicate that the image is a good candidate for intensity based entropy segmentation. If desired, a combination of intensity based entropy and edge orientation based entropy may be used for segmentation.

As illustrated in FIG. 3, after capturing an image with a background and vegetation, a gray scale image is produced (210). The image is segmented to remove the background and vegetation (215) as follows. Entropy values for pixels in the gray scale image are determined (220). As discussed above, the entropy value for the pixels may be based on intensity values of the pixels in the image or based on the edge orientation of the pixels. The entropy values are compared to one or more threshold values (230) and regions to be removed are identified as regions with entropy values greater than a maximum threshold value to remove vegetation (240). A high threshold is used to remove regions with high frequencies, corresponding to vegetation, such as trees and bushes. With intensity based entropy, a low threshold may be used to remove regions of low frequencies, which correspond to background, such as sky, roads, etc. Thus, for intensity based entropy, two threshold values, e.g., a high threshold and a low threshold (or equivalently a bandwidth threshold range) may be used. If desired, the threshold values may be pre-determined or adjusted based on the parameters of the image. Removal of the regions (240) includes clustering and pruning when the entropy is based on intensity. When the entropy is based on edge orientation, an edge strength value calculated for each pixel while determining entropy values (220) may be compared to a minimum threshold to identify and eliminate pixels that correspond to the background. Segmentation of the image may be completed using a mask over the regions to be removed (260), e.g., to remove the pixels under the mask, and the resulting image is stored or displayed (270). The resulting image may then be used for further processing, such as object recognition for augmented reality, or other similar processes. Using the segmented image for object recognition advantageously increases the speed of the process and lowers processing demands. The segmented image may be used with any desired object recognition process, which are well known in the art. Additionally, or alternatively, structures such as buildings in the image may be segmented with or without the use of a mask.

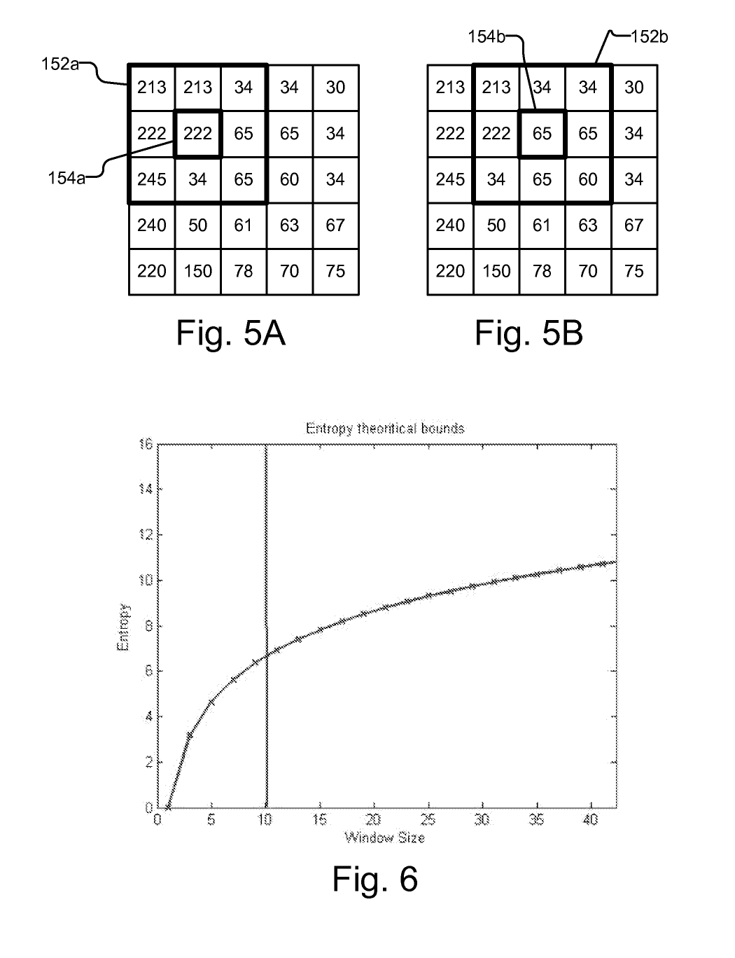

FIG. 4 is a flow chart illustrating the process of determining entropy values 220 using intensities of the pixels in the gray scale image. As illustrated in FIG. 4, a plurality of windowed pixel regions is generated as a window of pixels around each pixel in the gray scale image 222. FIGS. 5A and 5B, by way of example, illustrate windowed pixel regions within a portion of a gray scale image identifying the intensity (gray value) of each pixel, which may range from, e.g., 0-255. FIG. 5A illustrates gray values for a plurality of pixels in a portion of a gray scale image, with a 3×3 windowed pixel region 152a with a center pixel 154a, sometimes referred to herein as the windowed pixel. FIG. 5B illustrates the same portion of the gray scale image, and shows the 3×3 windowed pixel region 152b with the windowed pixel 154b moved to the right by one pixel. Thus, the window may be considered a sliding window that slides from one windowed pixel to the next.

The size of the window may be, e.g., 3×3 pixels as illustrated in FIGS. 5A, 5B or any other appropriate size, e.g., 9×9 pixels. The choice of the window size effects the entropy calculation, where a window that is too small does little or no averaging and a window that is too large does excess averaging. The window size determines the maximum possible entropy values. FIG. 6, by way of example, illustrates the maximum entropy plotted for different window sizes [k×k where k=1, 3, 5, 7 . . . ]. The maximum entropy is calculated based on Equation 2, assuming that each gray value in the specified window is unique and, thus, the region entropy is the highest possible. With a 9×9 window size, by way of example, the corresponding maximum entropy is approximately 6.33. The size of the window may be chosen heuristically or experimentally, e.g., where the size of the window is varied and the CDF examined, as discussed above, until the conditions for intensity based entropy segmentation are met.

Referring back to FIG. 4, the entropy value of each windowed pixel is calculated using the intensity values of the surrounding pixels in the window (223), e.g., using Equation 2. Accordingly, the probability of each intensity value in the windowed pixel region is calculated based on its frequency within that windowed pixel region and that probability is used to determine the entropy value for the windowed pixel. For example, as illustrated in FIG. 5A, the probability of each intensity value can be related inversely to frequency as shown in Table 1, below.

TABLE 1

P(245) = 1/9
P(213) = 2/9
P(222) = 2/9
P(65) = 2/9
P(34) = 2/9

Using Equation 2, the average entropy of the windowed pixel 154a can then be calculated as follows:

E_{windowed pixel 154a}=−(P(245)*ln P(245)+P(213)*ln P(213)+P(222)*ln P(222)+P(65)*ln P(65)+P(34)*ln P(34))=1.5810 eq. 3

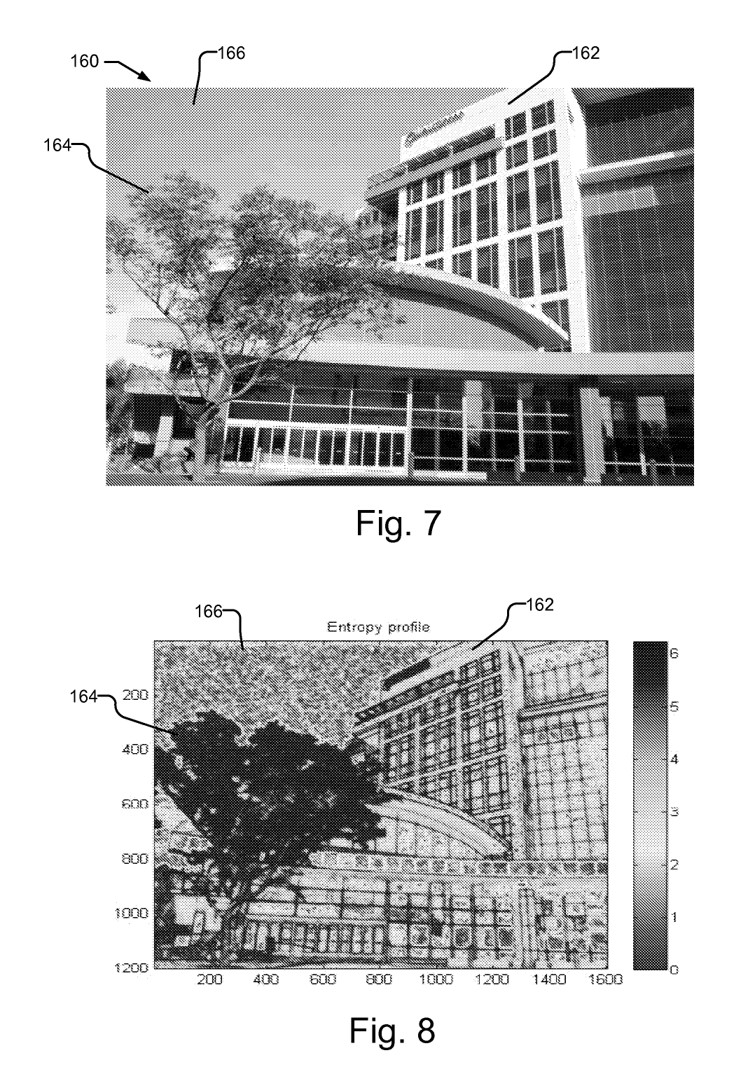

As an illustration of determining entropy values using intensities of the pixels, reference is made to FIGS. 7 and 8. FIG. 7 is an example of a gray scale of a captured image 160 of a building 162 and includes a tree 164 and sky 166. FIG. 8 is an intensity entropy profile of the image, after rendering the image in gray scale. The entropy distribution in FIG. 8 is indicated on the bar on the right of the image. As illustrated in FIG. 8, the tree 164 has high entropy compared to other parts of the image, such as building 162 or sky 166, although parts of the building 162 also have high entropy (comparable to the entropy in the tree 164).

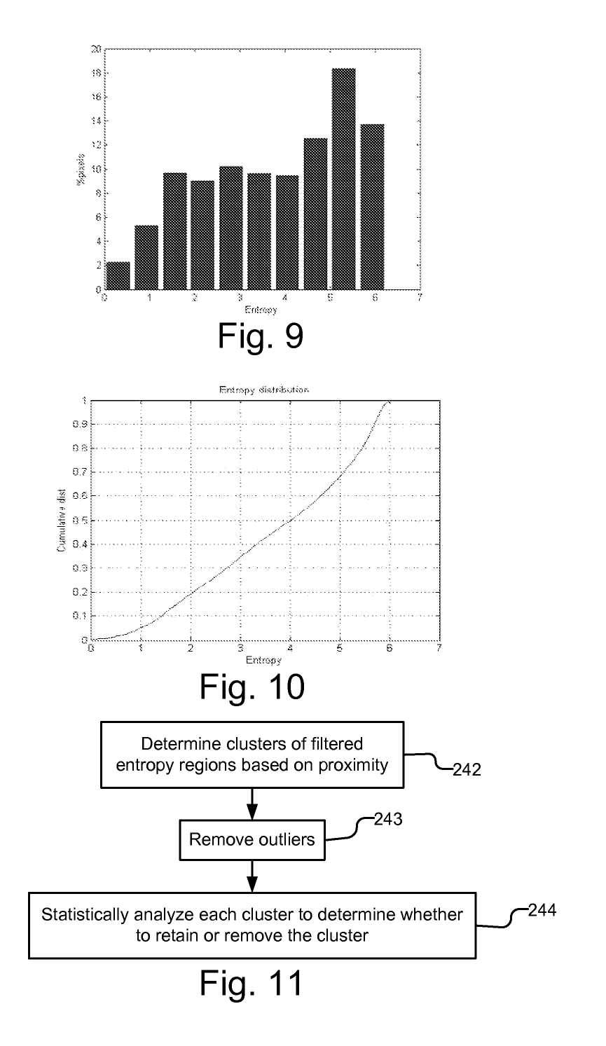

FIGS. 9 and 10 visualize the distribution of entropy over the image 160. FIG. 9 illustrates an entropy histogram of the image 160, while FIG. 10 illustrates the cumulative distribution function (CDF) of the intensity entropy of the entire image 160. As discussed above, if the entire image 160 has a high entropy, differentiation using intensity based entropy is difficult. A uniform entropy distribution in the image, as illustrated in FIG. 10, indicates that the image is a good candidate for segmentation using intensity based entropy because the thresholds will clearly demarcate different regions.

As discussed in FIG. 3, the entropy values are compared to one or more threshold ranges (230). The threshold selection is related to the window size used. High entropy may be classified as a function of the maximum entropy ('MaxEnt') possible in the image as illustrated in FIG. 6. For example, the threshold for selecting high entropy points (corresponding to vegetation regions) may be set to a large percentage of the maximum entropy, such as greater than 90%, or more specifically greater than 92%. Thus, the threshold may be written as [MaxEnt*0.92-MaxEnt] i.e. [5.82-6.33]. With a threshold selected for high entropy, the high frequency locations, i.e., vegetation, are chosen for removal. Similarly, background areas in the image, such as sky, ground, pathways or other homogenous regions in the image can be removed by using low entropy thresholds, i.e., a smaller percentage of the maximum entropy, such as less than 40% or more specifically less than 32%, resulting in entropy values of [0-2]. The threshold or thresholds used can be tuned based on the desired application. For removal of trees in an image, the threshold may be set aggressively in order to minimize false alarms. If desired, the thresholds may be selected based on the greatest/least entropy calculated for any windowed pixel regions in the image or based on the CDF.

Additionally, from FIG. 8, it is evident that not all high entropy locations correspond to trees or image noise. Because intensity entropy does not use any structural information, regions in the image including patterns or reflections on buildings may be identified as having high entropy. Accordingly, segmentation of these regions uses additional filtering in the form of clustering and pruning of the high entropy locations.

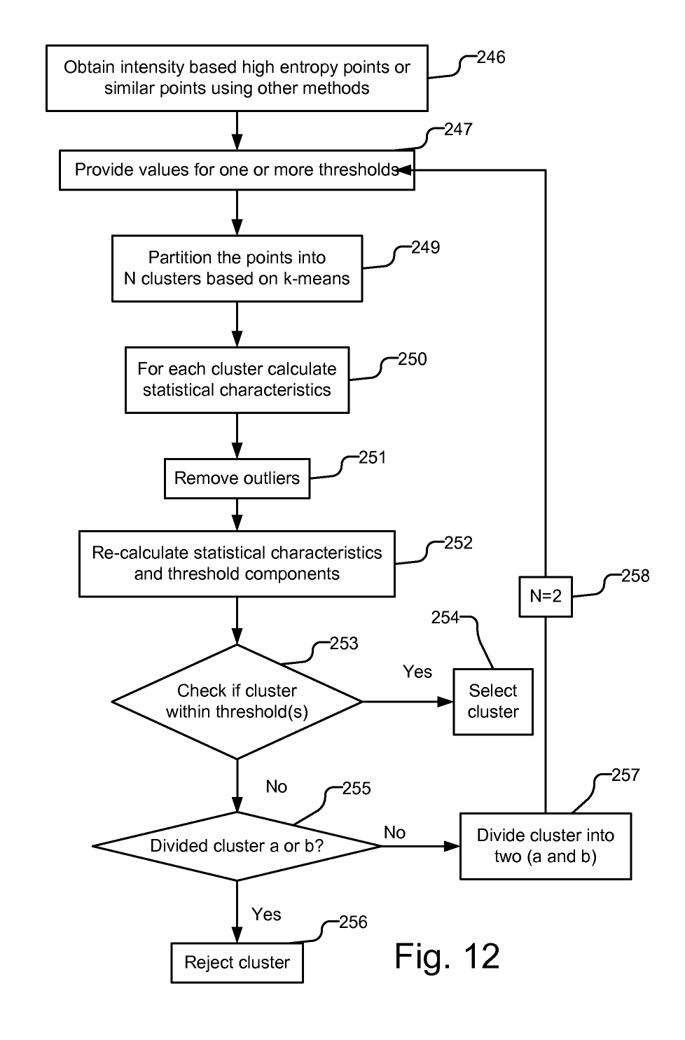

FIG. 11 is a flow chart illustrating a general removal process (240) using clustering and pruning. As illustrated, clusters of filtered entropy regions are determined based on proximity (242). The points with high entropy are clustered together based on their proximity. For example, for each cluster a centroid may be obtained and the distances of all the points in the cluster from the centroid are determined and stored. Each of the clusters obtained are pruned for outliers (243). Each cluster is assessed for ‘quality’ through statistical analysis to determine whether to retain or remove the cluster (244). and then assessed for their ‘quality’. Various statistical measures are used to either retain the cluster or a part of it, or discard the entire cluster.

FIG. 12 is a flow chart illustrating in more detail segmentation process (240) using clustering and pruning. Intensity based high entropy points, or other similar points such as low entropy points, are obtained (246). The selection criteria for each cluster are related to the statistical characteristics associated with the distance of the cluster points from the cluster centroid. Selection criteria may include, e.g., the distance between the mean and the median, the ratio of the standard deviation to the mean, the density of the high (low) entropy points determined by, e.g., the ratio of the number of points in a cluster to the square maximum distance (maximum distance is the distance of the farthest point in the cluster from the cluster centroid), and the distance to the interquartile range (IQR). If any of these statistical characteristics are outside their respective thresholds, the cluster is not a good candidate, and is either divided into two clusters or rejected after repeating the process. Thus, the one or more statistical characteristics threshold values are provided (247). By way of example, the statistical characteristic thresholds that are set include the maximum distance between mean and median (m1), the ratio of the standard deviation to the mean (m2), and the minimum entropy density (m3) and the distance to interquartile range (IQR) (m4). Additional, fewer or other criteria may be used if desired. The thresholds may be predetermined or determined based on a characteristic of the image being analyzed.

The high entropy points are partitioned into N clusters based on k-means (249), for example, five clusters may be used. By way of example, N may be preselected or chosen based on a characteristic of the image. As is well known in the art, k-means is a method for cluster analysis that partitions n points into k clusters, where k<=n, in which each point belongs to the cluster with the nearest mean or centroid. If desired, other clustering techniques may be used, such as fuzzy c-means clustering, QT clustering, locality-sensitive hashing or graph-theoretic methods.

For each cluster, the statistical characteristics related to the proximity of the cluster points to a cluster centroid are calculated (250). For example, for each cluster the mean, median, IQR, standard deviation, and the distance of points in the cluster from the centroid are calculated, from which the above-described statistical characteristics can be determined, including the distance between the mean and the median, the ratio of the standard deviation to the mean, the density of the high (low) entropy points, and the distance to the IQR. As is well understood in the art, the mean for any data set, is the sum of the observations divided by the number of observations. The mean of the data is intuitive when the data fits a Gaussian distribution and is relatively free of outliers. In the current context, within each cluster, the mean distance may be computed by averaging the distances of all the points from the centroid of the cluster. The median is described as the number separating the higher half of the observations or samples, from the lower half. The median of a finite list of numbers can be found by arranging all the observations from lowest value to highest value and selecting the middle value. The median is used when the distribution is skewed, and less importance is given to the outliers. Standard deviation is a measure of variability or dispersion of a data set. A low standard deviation indicates that the observations are close to the mean, whereas high standard deviation indicates that the observations are spread out. The interquartile range (IQR) is a robust estimate of spread of the data, since changes in the upper and lower 25% of the data do not affect it. If there are outliers in the observations, then IQR is more representative than the standard deviation as an estimate of the spread of data. The density of the cluster is the ratio of the number of points in the cluster to the square of the maximum distance.

Outliers may then be removed (251). For example, outliers may be determined as points having a difference between the point's distance from the centroid and the cluster median that is greater than a desired amount, e.g., a multiple of the standard deviation, e.g., 3 times the standard deviation or IQR. The statistical characteristics and thresholding components are then re-calculated with any outliers removed (252). The selection criteria/metrics for each cluster are related to the statistical measures associated with the distance of the cluster points from the cluster centroid. Some thresholds/parameters that are tuned based on the data include the m1, m2, m3, and m4 thresholds discussed above.

Each cluster is then assessed to determine if it is within the one or more thresholds (253). For example, if a cluster has a maximum distance between mean and median greater than m1, a ratio of standard deviation to the mean greater than m2 or a density less than m3, the cluster is selected to be retained (254). If the cluster is not within any of the thresholds, it is determined whether the cluster has already been divided (255) and if so, the cluster is rejected (256), i.e., is segmented from the image. If the cluster has not been divided, the cluster is divided into two (257) by returning the rejected cluster to step 247 with N=2 (258) for the partitioning of the cluster based on k-means at step 249.

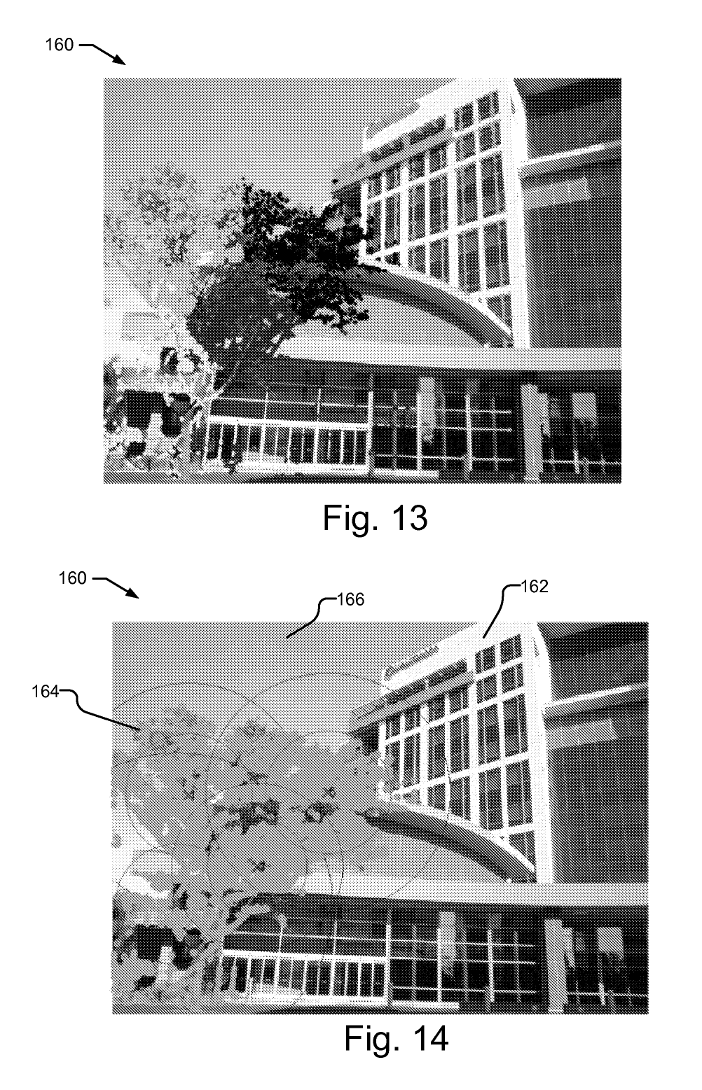

FIG. 13 illustrates image 160 after clustering high entropy points using k-means with the number of clusters N=5. The clusters identified in FIG. 13 are before outlier pruning (251) and cluster selection (253). FIG. 14 illustrates the clusters selected to be removed, i.e., segmented from the image 160, after outlier pruning as discussed above, where the outer circles are the mean distance from the cluster centroid and the inner circles are a selected fraction, e.g., 75% of the mean distance. As can be seen in FIG. 14, the tree 164 is selected for removal, while clusters that were associated with the building 162 are retained. It should be understood that the process described in FIG. 12 is used similarly to remove low frequency background regions, such as the sky 166, by obtaining low entropy points in step 246, as opposed to high entropy points and using appropriately selected values for the thresholds for the statistical characteristics.

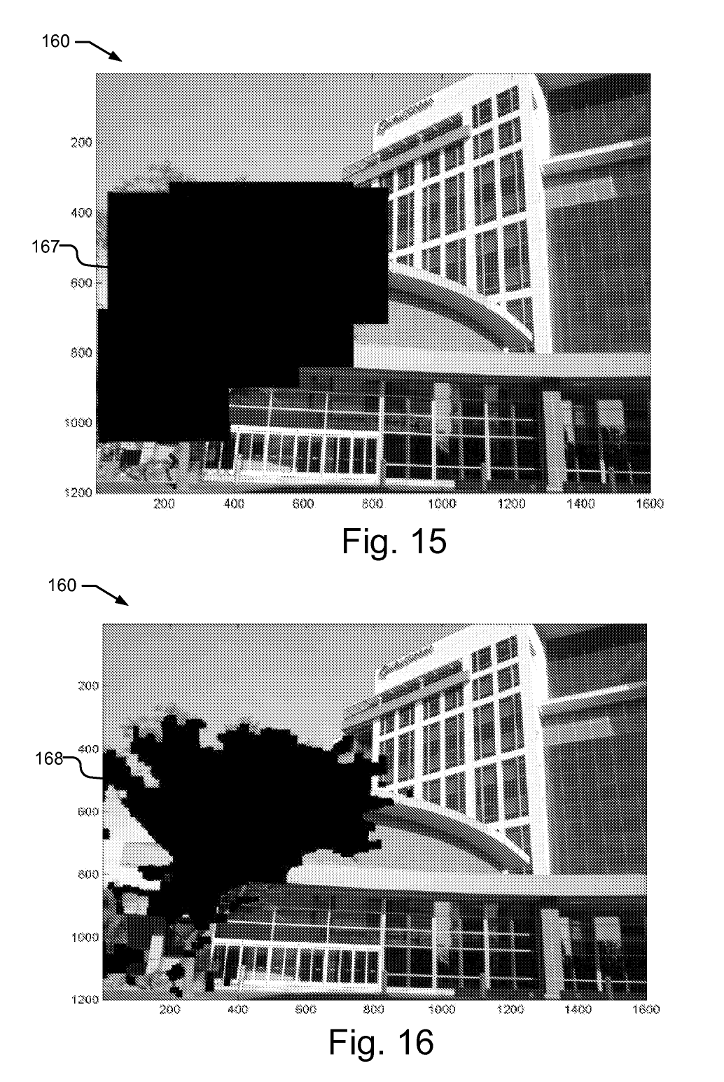

FIG. 15 illustrates the image 160 with the final mask 167 created using the segmented clusters from FIG. 14, as described in FIG. 2. The final mask 167 shown in FIG. 15 is created based on the cluster statistics themselves, where the cluster centroids and radii (i.e., maximum distance of a point to the centroid) are used to generate the final mask 167, e.g., by creating squares with a size k*radii (k=0.75) with the cluster centroid as the center. FIG. 16 is similar to FIG. 15, but illustrates a final mask 168 that is created based on the points in the clusters using morphological techniques, e.g., using MATLAB morphological operations, such as imopen, imdilate, imclose and imfill using a flat square structural element (size=15), which is well known in the art.

As discussed in FIGS. 1 and 3, the entropy values used in the entropy based image segmentation process 200 may be based on edge orientation as opposed to intensity. With entropy based on edge orientation, determining entropy values for pixels within the image (220) includes the edge detection block 208 and the edge orientation computation block 209 shown in FIG. 1. Because background regions have low edge strength, the background regions in the image are removed during edge detection by removing pixels with a calculated edge strength that is less than a threshold. After edge detection and edge orientation computation to determine the edge entropy, the edge orientation based segmentation process compares the entropy values to a threshold (230 in FIG. 3) and removes the regions with entropy values greater than a threshold to remove vegetation from the image (240/250). Edge orientation based entropy implicitly uses structural information, and therefore does not require the clustering step, compared to the intensity based entropy, which does not explicitly take any structural information into consideration, and thus, relies on clustering. The final mask may then be created in the mask creation block 204 (of FIG. 1). Additionally, or alternatively, structures such as buildings in the image may be segmented with or without the use of a mask.

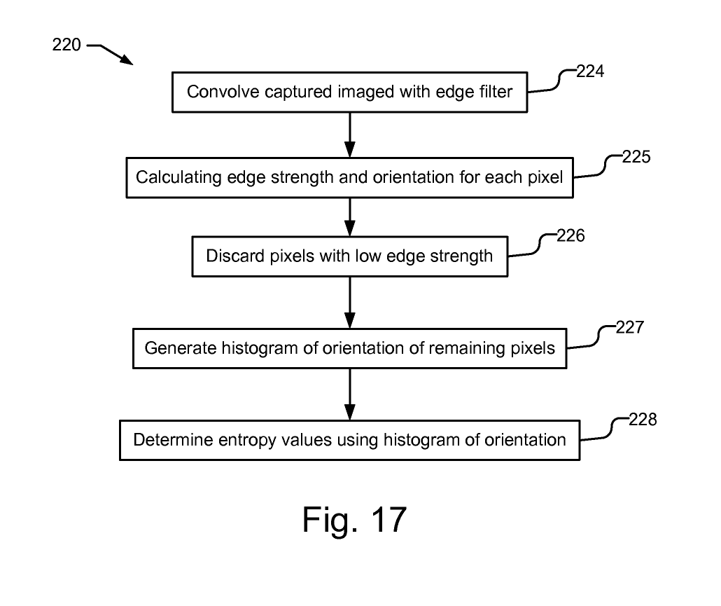

FIG. 17 is a flow chart of determining entropy values based on edge orientation (220). As illustrated, the captured image is convolved with an edge filter (224), such as a 3×3 Sobel kernel or other similar filters. The edge strength and orientation for each pixel is calculated (225). The calculated edge strength for the pixels is compared to threshold, which may be preselected or based on a characteristic of the image, and pixels with low edge strength are discarded (226), e.g., by setting their voting weight to be 0, while pixels with an adequate edge strength have their voting weight set to be 1. As discussed above, removing pixels with low edge strength, removes background regions from the image due to the low edge strength of background regions. The orientations of the remaining pixels are then quantized by generating a histogram of orientation (227), e.g., with the voting weight of the pixels appropriately set. By way of example, the histogram may use 16 bins of orientations. The entropy is then computed using the histogram of orientation (228).

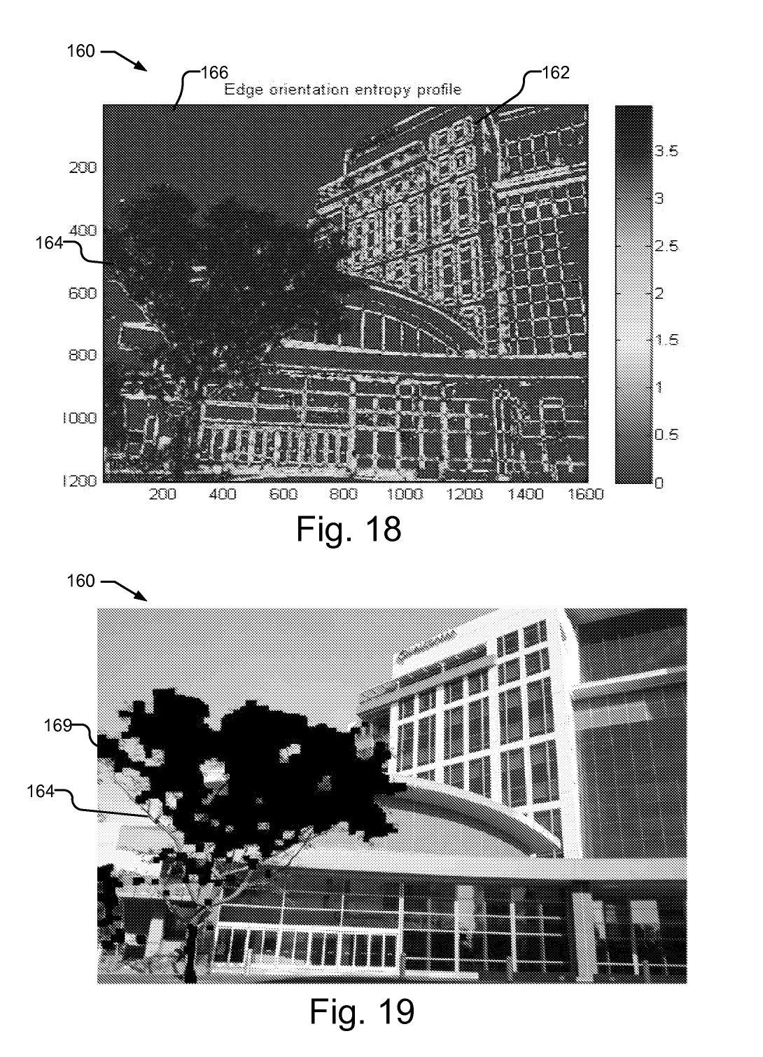

FIG. 18 is an edge orientation entropy profile of image 160, with the entropy distribution indicated on the bar on the right of the image. As can be seen, the tree 164 has high entropy compared to other parts of the image, such as building 162 or sky 166.

FIG. 19 illustrates the image 160 with the final mask 169 created after applying a threshold to identify regions in image with large edge entropy. The threshold may be preselected or based on characteristics of the image. The final mask 169 is generated by applying morphology like opening and closing to an initial mask obtained from entropy filtering to remove isolated regions and fill holes on the mask.

If desired, the intensity based entropy process and the edge orientation based entropy process may be combined to compensate for limitations found in using only one and related statistics may be used, such as skewness and kurtosis. For example, intensity based entropy does not identify trees that have filled regions with no fluctuations in intensity values and edge orientation based entropy is overly sensitive to detailed patterns that may appear on buildings or roofs. By combining the two methods, these limitations are avoided.

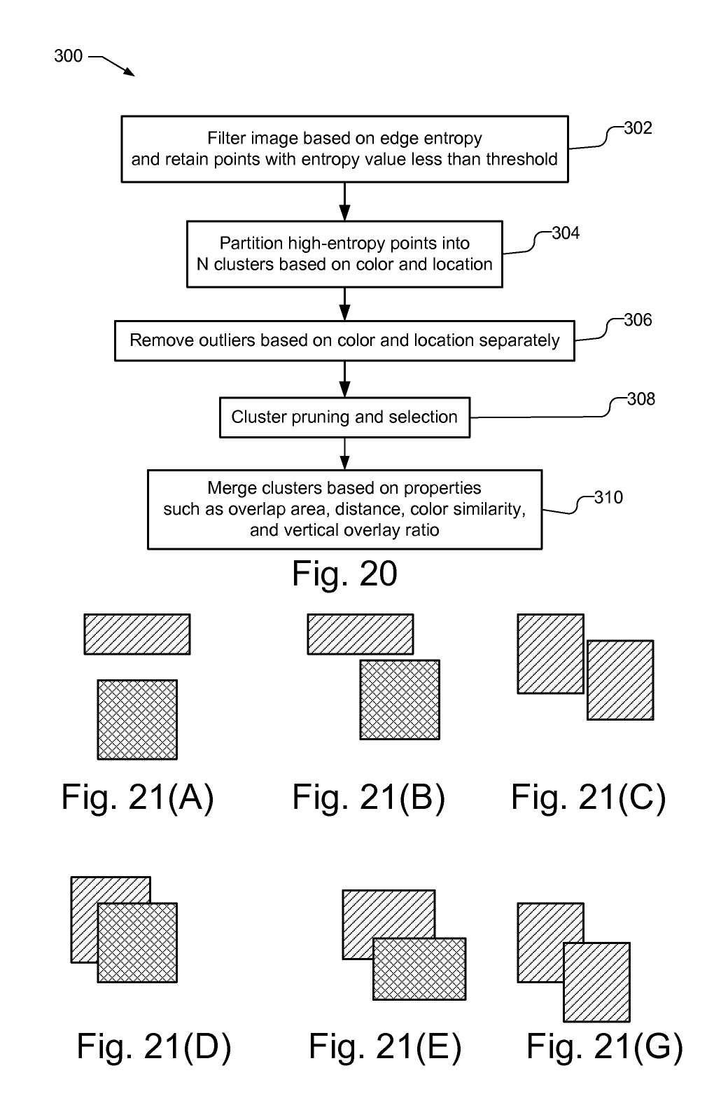

It may be desirable to distinguish between structures, such as buildings, that appear within a single image for object recognition or other similar purposes. Separation of structures may be performed using edge orientation based entropy segmentation with clustering and pruning based on location and color information, followed by the merger of clusters. Thus, for example, after generating a high entropy mask for segmenting high entropy regions, such as vegetation, the area occupied by the mask is removed from the image and the clustering and merging processes for separating buildings is performed on the remaining area. FIG. 20 is a flow chart of a method 300 of separating structures, such as buildings, in an image. As illustrated in FIG. 20, the image is filtered based on edge entropy values and points in the image that have an entropy value smaller than a threshold are retained (302), which may have already been performed during the segmentation of the image to remove vegetation. The remaining low-entropy points are then clustered by partitioning into N clusters based on distance and color of the pixels in the captured image (304). Color spaces such as HSV and Lab may be used. Color and distance for each point may be combined into a single combined vector and clustering performed on the combined vector. Partitioning into N clusters may be performed using k-means, as described above. With the assumption that buildings are mostly vertically separated, the y coordinate of each point's location is given less weight in clustering, e.g., half, than other attributes, including the x coordinate. The outliers may then be removed based on color and location separately (306). Cluster pruning and selection (308) is performed by comparing statistical characteristics to thresholds. For example, the spatial density of the clusters and the color/spatial mean to median difference may be compared to thresholds. If a cluster is within threshold for the statistical characteristics used, it is retained. If a cluster is outside of a threshold for the statistical characteristics, the cluster may be split into sub-clusters, and the statistical characteristics recalculated and compared to appropriate thresholds. The sub-clusters are then either retained if within the thresholds or is discarded. The clusters are then merged based on relationships of the clusters, including properties such as overlap area, distance, color similarity, and vertical overlay ratio (308). Merger of clusters may be based on variable relationships of the different properties as illustrated in Table 2 below, where there are clusters C1={center1, std1} and C2={center2, std2}, where center represent the center of the cluster and stdi represents the standard deviation for the points on in the cluster i, Overlapx=overlap along the x direction, Overlapy=overlap along the y direction, Overlap=overlapx*overlapy/min(std1(1)*4*std1(2)*4, std2(1)*4*std2(2)*4); dist=distance between center 1 and center 2, and colordiff=the color difference between the clusters. The merger rules may then be written as shown in Table 2.

TABLE 2
if( overlap>0.4 )

merge = 1

else if( overlap >0.2 && (((overlap_x>0.6)&& (colorDiff <
0.25)) || colorDiff < 0.2))

merge = 1

else

if( overlap_x>0.8 && dist<size(img,1)/4 )

merge = 1;

elseif( overlap_x>0.4 && overlap_y>0.1 &&
colorDiff < 0.2 )

merge = 1;

elseif( overlap_x<0.4 && overlap_y>0.8 &&
dist<20 && colorDiff < 0.2)

merge = 1;

elseif( overlap_x<0.4 && overlap_y>0.8 &&
dist<30 && colorDiff < 0.1)

merge = 1;

end

end

FIGS. 21A-G illustrate relationships between clusters where each figure includes two clusters that are considered to belong to one building. For example, FIG. 21A illustrates clusters with complete x-axis overlap. FIG. 21B illustrates clusters with a large x-axis overlap and a small distance between the clusters. FIG. 21C illustrates clusters with a large y-axis overlap, similar color, and a small distance between the clusters. FIG. 21D illustrates clusters with a large overlap area. FIG. 21E illustrates clusters with a large x-axis overlap and a small overlap area. FIG. 21F illustrates clusters with a small overlap area and similar color.

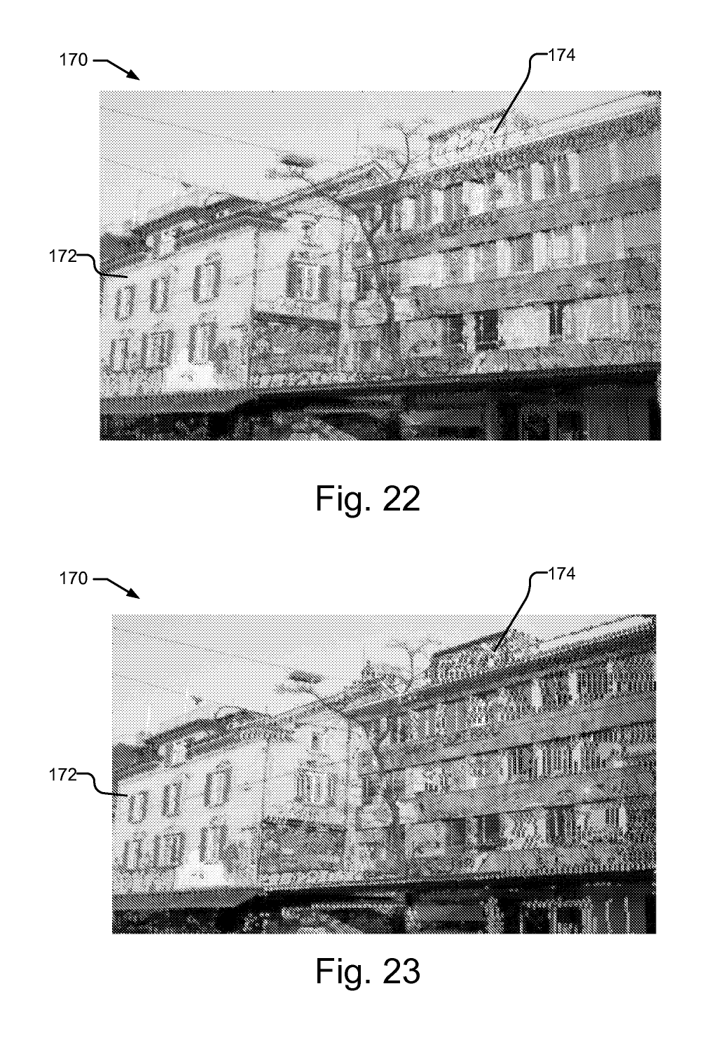

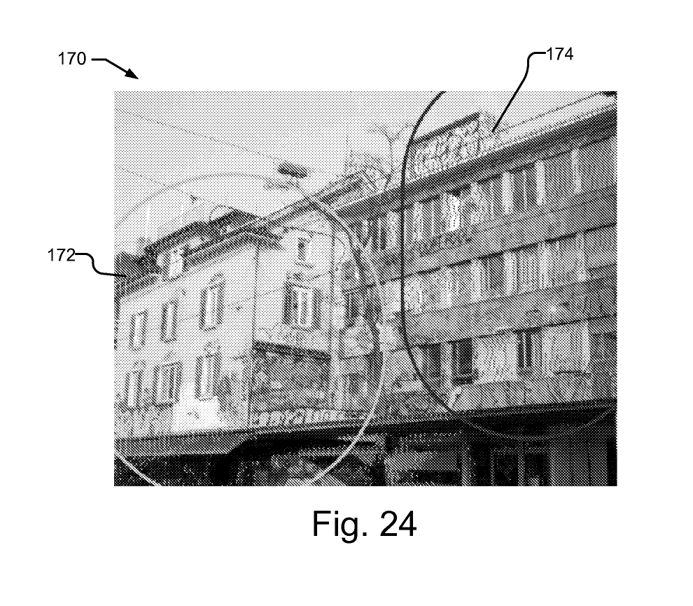

FIG. 22 illustrates edge orientation entropy points with clustering (each cluster having a unique color) using k-means with N=5 in an image 170 with multiple buildings 172 and 174. FIG. 23 illustrates image 170 after cluster pruning and selection is performed and FIG. 24 illustrates the image 170 after clusters are merged. As can be seen in FIG. 24, the merged clusters align with the separated buildings 172 and 174.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
producing a gray scale image that includes a background and vegetation;
segmenting the image to remove the background and vegetation from the image to produce a segmented image, wherein segmenting the image comprises:
determining entropy values for pixels in the image;
comparing the entropy values to a threshold value for maximum entropy;
removing regions in the image having entropy values greater than the threshold value for maximum entropy to remove vegetation from the image;
wherein the background is removed using a minimum threshold value that is compared to at least one of the entropy values for pixels in the image and an edge strength value calculated for each pixel while determining entropy values; and
storing the segmented image.

2. The method of claim 1, using the segmented image with the background and vegetation removed for object recognition.

3. The method of claim 1, wherein determining entropy values is based on pixel intensities and the background is removed using the minimum threshold value that is compared to at least one of the entropy values for pixels in the image.

4. The method of claim 3, wherein determining entropy values based on pixel intensities comprises:
generating a window of pixels around each of the pixels; and
calculating the entropy values of each of the pixels using the intensity values of the pixels in the window around each of the pixels.

5. The method of claim 4, further comprising:
determining clusters of entropy regions based on proximity; and
statistically analyzing each cluster to determine whether to retain or remove the cluster.

6. The method of claim 5, wherein statistically analyzing each cluster uses at least one of entropy density, mean, variance, variance, and skewness.

7. The method of claim 5, wherein segmenting the image comprises masking clusters of pixels based on entropy thresholds and the statistical analysis.

8. The method of claim 5, wherein clusters of regions are determined using k-means clustering.

9. The method of claim 1, wherein determining entropy values is based on edge orientation and the background is removed using the minimum threshold value that is compared to the edge strength value calculated for each pixel while determining entropy values.

10. The method of claim 9, wherein determining entropy values based on edge orientation comprises:
convolving the image with an edge filter;
calculating the edge strength value and orientation for each pixel;
discarding pixels with an edge strength value below the minimum threshold; and
generating a histogram of orientation of remaining pixels, wherein determining entropy values uses the histogram of orientation.

11. The method of claim 10, further comprising:
partitioning areas of the image that are not removed into clusters based on color and location;
removing outliers based on color and location; and
merging clusters based on at least one of overlap area, distance, color, and vertical overlay ratio to separate buildings in the image.

12. A mobile platform comprising:
a camera for capturing an image;
a processor connected to the camera to receive the image;
memory connected to the processor;
a display connected to the memory; and
software held in the memory and run in the processor to produce a gray scale image from a captured image that includes a background and vegetation, to segment the image to remove the background and vegetation to produce a segmented image by determining entropy values for pixels in the image; comparing the entropy values to a threshold value for maximum entropy; removing regions in the image having entropy values greater than the threshold value for maximum entropy to remove vegetation from the image; wherein the background is removed using a minimum threshold value that is compared to at least one of the entropy values for pixels in the image and an edge strength value calculated for each pixel while determining entropy values; and to store the segmented image in the memory.

13. The mobile platform of claim 12, wherein the software causes the processor to using the segmented image with the background and vegetation removed for object recognition.

14. The mobile platform of claim 12, wherein entropy values are determined based on pixel intensities and the software causes the processor to remove the background using the minimum threshold value that is compared to the entropy values for pixels in the image.

15. The mobile platform of claim 14, wherein the software causes the processor to determine entropy values based on pixel intensities by causing the processor to generate a window of pixels around each of the pixels, and to calculate the entropy values of each of the pixels using the intensity values of the pixels in the window around each of the pixels.

16. The mobile platform of claim 15, wherein the software causes the processor to determining clusters of entropy regions based on proximity; and to statistically analyze each cluster to determine whether to retain or remove the cluster.

17. The mobile platform of claim 16, wherein each cluster is statistically analyzed with at least one of entropy density, mean, variance, variance, and skewness.

18. The mobile platform of claim 16, wherein the image is segmented to remove regions by masking clusters of pixels based on entropy thresholds and the statistical analysis.

19. The mobile platform of claim 16, wherein clusters of regions are determined using k-means clustering.

20. The mobile platform of claim 12, wherein entropy values are determined based on edge orientation and the background is removed using the minimum threshold value that is compared to the edge strength value calculated for each pixel while determining entropy values.

21. The mobile platform of claim 20, wherein the software causes the processor to determine entropy values based on edge orientation by causing the processor to convolve the image with an edge filter; calculate the edge strength value and orientation for each pixel; discard pixels with edge strength below the minimum threshold; and generate a histogram of orientation of remaining pixels, wherein entropy values are determined using the histogram of orientation.

22. The mobile platform of claim 21, wherein the software further causes the processor to partition areas of the image that are not removed into clusters based on color and location; remove outliers based on color and location; and merge clusters based on at least one of overlap area, distance, color, and vertical overlay ratio to separate buildings in the image.

23. A system comprising:
means for producing a gray scale image that includes a background and vegetation;
means for segmenting the image to remove the background and vegetation from the image to produce a segmented image, the means for segmenting the image comprising:
means for determining entropy values for pixels in the image;
means for comparing the entropy values to a threshold value for maximum entropy;
means for removing regions in the image having entropy values greater than the threshold value for maximum entropy to remove vegetation from the image;
wherein the background is removed using a minimum threshold value that is compared to at least one of the entropy values for pixels in the image and an edge strength value calculated for each pixel while determining entropy values; and
means for storing the segmented image.

24. The system of claim 23, means for using the segmented image with the background and vegetation removed for object recognition.

25. The system of claim 23, wherein the means for determining entropy values generates a window of pixels around each of the pixels and calculates the entropy values of each of the pixels using intensity values of the pixels in the window around each of the pixels; and the background is removed using the minimum threshold value that is compared to at least one of the entropy values for pixels in the image.

26. The system of claim 25, further comprising:
means for determining clusters of entropy regions based on proximity; and
means for statistically analyzing each cluster to determine whether to retain or remove the cluster.

27. The system of claim 26, wherein the means for segmenting the image to remove regions masks clusters of pixels based on entropy thresholds and the statistical analysis.

28. The system of claim 23, wherein the means for determining entropy values convolves the image with an edge filter; calculates the edge strength value and orientation for each pixel; discards pixels with edge strength below the minimum threshold value to remove the background; and generates a histogram of orientation of remaining pixels, wherein the means for determining entropy values uses the histogram of orientation.

29. The system of claim 28, further comprising:
means for partitioning areas of the image that are not removed into clusters based on color and location;
means for removing outliers based on color and location; and
means for merging clusters based on at least one of overlap area, distance, color, and vertical overlay ratio to separate buildings in the image.

30. A computer-readable medium including program code stored thereon, comprising:
program code to produce a gray scale image from a captured image that includes a background and vegetation;
program code to segment the image to remove the background and vegetation to produce a segmented image, comprising:
program code to determine entropy values for pixels in the image;
program code to compare the entropy values to a threshold value for maximum entropy;
program code to remove regions in the image having entropy values greater than the threshold value for maximum entropy to remove vegetation from the image;
wherein the background is removed using a minimum threshold value that is compared to at least one of the entropy values for pixels in the image and an edge strength value calculated for each pixel while determining entropy values; and
program code to store the segmented image in a memory.

31. The computer-readable medium of claim 30, further comprising program code to use the segmented image with the background and vegetation removed for object recognition.

32. The computer-readable medium of claim 30, wherein the program code to determine entropy values uses pixel intensities and includes program code to generate a window of pixels around each of the pixels, and program code to calculate the entropy values of each of the pixels using the intensity values of the pixels in the window around each of the pixels and program code to remove the background using the minimum threshold value that is compared to the entropy values for pixels in the image.

33. The computer-readable medium of claim 32, further comprising program code to determine clusters of entropy regions based on proximity; and program code to statistically analyze each cluster to determine whether to retain or remove the cluster.

34. The computer-readable medium of claim 30, wherein the program code to determine entropy values uses edge orientation and includes program code to convolve the image with an edge filter; program code to calculate the edge strength value and orientation for each pixel; program code to discard pixels with an edge strength below the minimum threshold to remove the background; and program code to generate a histogram of orientation of remaining pixels, wherein entropy values are determined using the histogram of orientation.

35. The computer-readable medium of claim 34, further comprising program code to partition areas of the image that are not removed into clusters based on color and location; program code to remove outliers based on color and location; and program code to merge clusters based on at least one of overlap area, distance, color, and vertical overlay ratio to separate buildings in the image.
